(19) United States
(12) Patent Application Publication
(10) Pub. No.: US 2008/0284263 A1
(43) Pub. Date: Nov. 20, 2008

(54) Water Jacket for a Rotary Machine and Rotary Machine Comprising Same

(75) Inventor: Bruno Dessirier, St Germain en Laye (FR)

Correspondence Address: MATTHEW R. JENKINS, ESQ., 2310 FAR HILLS BUILDING, DAYTON, OH, 45419, US

(73) Assignee: TELMA, Saint-Ouen-l'Aumône (FR)

(21) Appl. No.: 11/570,940

(22) PCT Filed: Jun. 30, 2005
(86) PCT No.: PCT/FR2005/001662

§ 371 Date: Dec. 19, 2006

(30) Foreign Application Priority Data
Jun. 30, 2004 (FR) 04 07 228

(51) Int. Cl. H02K 1/20

(52) U.S. Cl. 310/54

(57) ABSTRACT

The invention concerns a water jacket for a rotary machine, the water jacket comprising at least one conduit (11) designed to be in cooling contact with at least one part of the machine and having at least one inlet coupling (12) and at least one outlet coupling for a coolant between which the conduit(s) (11) extend. The water jacket comprises an inner wall (17) and an outer wall (18) made of two different materials. The invention also concerns a rotary machine equipped with such a water jacket and an electromagnetic retarder provided with such a water jacket.

### FIELD OF THE INVENTION

The invention concerns a cooling jacket for a rotary machine, in particular for an electrical rotary machine equipping a motor vehicle, and a rotary machine, in particular an electromagnetic retarder, comprising such a cooling jacket.

In the technical field of motor vehicles, the need for particularly well functioning cooling is not limited to the thermal engine by means of which the motor vehicle is driven, but also concerns auxiliary equipment such as a generator or an electromagnetic retarder intended to brake the transmission shaft of the vehicle. The majority of the equipment is air cooled. However, when air cooling, which is not very difficult to install, proves to be insufficient, the machines, and in particular the largest ones intended to undergo higher forces, must be cooled by a fluid circulating in a cooling circuit. Such a fluid is for example water, it being understood that this water comprises at least one additive such as antifreeze, for example glycol. The fluid circulates in a channel constituting, together with a heat exchanger, a cooling circuit.

Moreover, machines such as thermal engines are provided with a cooling channel consisting of a set of highly branched pipes to cause the fluid to pass practically in all corners of the machine. In a comparable fashion, rotary machines such as electromagnetic retarders are machines whose cooling must also reach the smallest recesses in order to avoid the formation of “hot spots”, a phenomenon that is harmful to the functioning and endurance of the machine. This cooling can be achieved, for example, by a channel having the general shape of a helix surrounding the machine to be cooled, since these machines do not have sufficiently thick walls for pipes for a cooling fluid to be integrated therein.

### PRIOR ART

Rotary electrical machines, whether it is a case of generators, reversible machines such as generator/starters, or electromagnetic retarders, and the electrical supply means to these rotary electrical machines, form assemblies generally comprising a stator through which there pass a shaft and a rotor assembled with a shaft so as to have an external cylindrical face of the rotor close to an internal cylindrical face of the stator with a slight air gap interposed between the rotor and the stator. For the case of an electromagnetic retarder, the rotor comprises a field winding with coils of electric wires, able to generate a magnetic field in an annular ferromagnetic piece of the stator, which constitutes the armature and which is associated with a circuit cooling by means of a fluid such as water containing an additive as indicated above. The electrical supply to the coils of the rotor is provided by means of a generator, the armature of which forms part of the rotor. An electrical rotary machine of this type is described for example in the document EP-A-0 331 559.

A rotary machine such as, for example, the electromagnetic retarder described in the document cited above can be considered highly schematically to be an appliance in two parts: the first part consists of the rotor, which is in the form of a solid core intended to be attached to a shaft transmitting motive force that it is sought to brake, and a stator having the form of a cylindrical chamber surrounding the rotor.

On the electrical level, the coils of electric wires that conduct the excitation electric current of the retarder form part of the rotor, and the annular piece made from ferromagnetic material in which eddy currents are generated, generating a braking force and heating, forms part of the stator. In its most simple embodiment, the annular piece made from ferromagnetic material consists of a cylindrical drum surrounding the excitation winding with the interposing of a cylindrical air gap. As the annular piece made from ferromagnetic material is a fixed piece, it is easy to cool it by means of a fluid, even when it has complex shapes.

This is because, in order to obtain cooling of the annular piece, the cooling fluid is made to pass through a cooling channel, or cooling jacket, matching the shape of the annular piece. Advantageously, this cooling jacket comprises, as an integral part, the annular piece made from ferromagnetic material, which provides direct passage of the cooling fluid over the annular piece.

Thus the cooling jacket, or cooling channel, is advantageously formed by two cylindrical or helical walls, according to the embodiment chosen, one of which, the external wall, surrounds the other, the internal wall. The external wall being radially spaced apart from the internal wall, which consists partially of the annular piece, these two walls form, together with two lateral walls, a passage volume, or conduit, for the cooling fluid.

The integration of the annular piece made from ferromagnetic material in the cooling jacket ensures as well as possible direct contact between the cooling fluid and the annular piece. At the same time, the design of the cooling jacket in two parts makes it possible to produce complex shapes and to use traditional seals, O-ring seals or other, to make the two parts fluidtight

The length of this channel that is in direct contact with the machine to be cooled extends, for example, in a helix around the annular piece made from ferromagnetic material. According to an alternative solution, the length of this channel is formed by a plurality of straight pipes parallel to one another and disposed in parallel around the longitudinal axis of the machine to be cooled. For these two solutions, the length terminates at each of its two ends in a coupling, respectively inlet and outlet.

The length of channel forms, in both cases, in a motor vehicle equipped with such a rotary machine, together with an external heat exchanger, the remainder of the cooling channel and a drive pump, a cooling circuit for dissipating a fairly high quantity of heat to the outside. Advantageously, the cooling circuit of the rotary machine is connected to the cooling circuit of the thermal engine of the vehicle.

As indicated above, the initiation of a braking torque in an electrical magnetic retarder is based on the principle of eddy currents. This is because the stator inside which the rotor turns is subjected to an electromagnetic field. This field is generated by coils mounted on the rotor. These coils function in pairs. Each of the pairs of coils forms a magnetic field closing from one coil to the other, passing into the core of a first coil, then into the stator, then into the core of a second coil and into the rotor. Thus, when the rotor starts to rotate, the induction lines of the magnetic field formed by each of the pairs of coils pass through the ferromagnetic stator. The result is the initiation of currents induced in the conductive mass of the stator, called eddy currents. These currents cannot be located but, the resistance offered to them always being very small, they have an appreciable intensity and, according to Lenz's law, a direction such that they oppose, through their effects, the cause that gives them the direction, namely the rotation movement of the rotor. In this way, the rotation movement of the rotor generates a reverse rotation torque and therefore a braking torque. At the same time, the metal mass in which the eddy currents are generated heats up by Joule effect. The result is a loss of energy in the form of thermal energy or heat that it is sought to avoid in other types of rotary electrical machines, but that not only are accepted in the case of electromagnetic retarders but for optimum discharge of which all possible efforts are made so that the retarder can withstand even more losses of thermal energy and thus can be even more powerful.

The currents that pass through the stator heat the walls of the stator. To avoid a drop in performance of the retarder, the heat is discharged by cooling the walls of the stator. To this end, a chamber is formed in the external peripheral wall of the stator in order to be able to make a cooling fluid circulate therein, as described for example in the document EP-0 331 559. The cooling of the stator is therefore obtained by a heat exchange between the hot stator and the relatively less hot cooling fluid. However, the efficacy of this cooling depends partly on the dimensions of this cooling chamber or of the cooling jacket formed by a conduit (or conduits) surrounding the retarder. In order to obtain efficient cooling of the retarder, the cooling fluid must circulate in the cooling fluid jacket, and even in the entire circuit, at a fairly high speed. In addition, better convection of the heat is obtained by the generation of turbulences in the flow of the fluid. The effects of the turbulences are particularly promoted by a low height of the cooling jacket.

The cooling jacket formed by the single conduit or the conduits surrounding the rotary machine is a body having a relatively complex shape and therefore posing a certain number of problems for its manufacture. For this reason, the cooling jacket is often produced in two parts that are then joined by welding.

However, independently of the manner in which the cooling jacket is produced, a drop in temperature is found between the internal wall of the cooling jacket, that is to say between the wall forming the armature of the stator, and the external wall thereof. This difference in temperature between the two walls gives rise to different expansions for each of these walls, which causes internal tensions in the cooling jacket.

The aim of the invention is to propose a cooling jacket that is not subject to such stresses, or which is subject at the least to a lesser degree than the cooling jackets used up till now.

Moreover the proposed solution of the invention should make it possible at the same time to reduce the weight of the retarders, and possible their size also their manufacturing cost.

### OBJECT OF THE INVENTION

The aim of the invention is achieved with a cooling jacket comprising at least one conduit intended to be in heat-transfer contact with at least part of a rotary machine to be cooled and having at least one inlet coupling and at least one outlet coupling for a cooling fluid between which the conduit or conduits extend.

In accordance with the invention, the cooling jacket comprises an internal wall and an external wall produced in two different materials, the external wall surrounding the internal wall and being formed radially spaced apart therefrom in order to form the conduit through which the cooling fluid passes. The external wall and internal walls are assembled with two elastic seals to provide the fluidtightness of the conduit.

The use of two different materials respectively for the internal wall and external wall of the cooling jacket makes it possible to take account of the differential expansion between these two walls. This expansion can be essentially axial, essentially radial or have the two components.

Advantageously, the internal wall is produced from a ferromagnetic material and the external wall is produced from a castable non-magnetic material. The use of a ferromagnetic material for the internal wall makes it possible to integrate the armature of the stator in the cooling jacket. In other words, the use of a ferromagnetic material for producing the internal wall of the water jacket makes it possible to use the internal wall directly as the armature of the stator and thus obtain a direct heat-transfer contact between the armature of the stator and the cooling fluid.

The use of a castable material for producing the external wall makes it possible to obtain complex shapes of the external wall of the cooling jacket, the external wall is advantageously produced from a material that can be cast by gravity, under vacuum, or under pressure.

The differential expansion is all the better controlled since there exists between the external wall and internal wall an axial clearance allowing a relative longitudinal movement of the two walls, but also a radial clearance that for its part is compensated for by the presence of at least two elastic seals. Advantageously, but not necessarily, at least one of these elastic seals is an O-ring seal.

With regard to the materials able to be used for producing a cooling jacket according to the invention, a light alloy based on aluminium or magnesium is recommended for the external wall and a magnetic steel with a high limit of elasticity for the internal wall. The use of a light alloy for the external wall substantially reduces the weight of the electromagnetic retarders or other rotary electrical machines equipped with a cooling jacket according to the invention. The use of a lightly alloyed magnetic steel having a high limit of elasticity for the internal wall optimises the thermomechanical characteristics of the cooling jacket.

Producing the cooling jacket according to the invention in two parts, where applicable even in more parts, makes is possible to best adjust the height of the cooling fluid in the cooling jacket and consequently its heat exchange capacity. A small thickness of fluid increases the heat exchange and promotes the turbulence effects. The optimisation consists of the adjustment between the height of fluid and its effect on the pressure drops on the cooling circuit.

The main disadvantages of the retarders not using the present invention are the high weight, their bulk and maximum temperature that can they can withstand. Producing the cooling jacket in two different materials facilitates the manufacture of the cooling jacket and reduces the weight of the retarder. This principle makes it possible to use for example aluminium casting to facilitate the production of the external wall and in particular of its complex shapes for both the inlet and outlet couplings of the cooling jacket and for adapting the walls to facilitate the flows and avoid hot spots. These arrangements then afford optimisation of the functioning through control of the flow of fluid with turbulence, a minimisation of pressure drop and good distribution of the heat exchange surfaces. The use of aluminium casting moreover offers the advantage of an inexpensive manufacturing method providing a good compromise between weight and mechanical strength.

With regard to the detailed design of the cooling jacket, it has proved advantageous for the inlet coupling and the outlet coupling or couplings each to be orientated at least approximately along the orientation of the inlet axis or of the outlet axis of the corresponding conduit.

Thus, when the cooling jacket comprises a helical conduit having at least one turn intended to surround at least part of the machine to be cooled, the inlet coupling and the outlet coupling are advantageously orientated along a tangential axis or plane passing though a respectively inlet and outlet circumferential zone of the cooling jacket. The inlet coupling and outlet coupling are also advantageously disposed, in an axial view of the cooling jacket, with a slight angular offset between the two couplings.

According to an advantageous additional characteristic, the inlet coupling, the outlet coupling and the conduit have, all along the travel of the cooling fluid, a constant area of their cross-sections of flow.

Moreover, it has proved useful to provide, between the external wall and internal wall of this type of cooling jacket, means granting a helical path to the cooling fluid in order to prevent the cooling fluid passing directly from the inlet coupling to the outlet coupling. These means can consist, for example, of a difference in level between the junctions of the helical circuit respectively with the feed coupling and the outlet coupling. These means can also consist of a changing low wall conformed so as to give the cooling fluid a favoured direction of flow.

Apart from a simple or single turn, it is also conceivable for the cooling jacket to comprise two adjacent turns with a common inlet coupling and an individual outlet coupling for each turn. The opposite design, that is to say adjacent turns with an individual inlet coupling for each turn and a common outlet coupling, is also conceivable.

The aim of the invention is also achieved with a rotary electrical machine comprising a stator surrounding a rotor, the stator and rotor being axially orientated, and the rotary electrical machine comprising a cooling jacket intended to cool the stator, this cooling jacket corresponding to the one described above.

The aim of the invention is more particularly achieved with an electromagnetic retarder comprising a stator surrounding a rotor, the rotor comprising induction coils and the stator comprising an armature, and a cooling jacket intended to cool the stator, this cooling jacket comprising an internal wall and an external wall surrounding the internal wall, the internal wall being formed by the armature of the stator.

### BRIEF DESCRIPTION OF THE DRAWINGS

Other characteristics and advantages of the present invention will emerge from the following description of two embodiments of the invention, the description being given with reference to the drawings, in which:

FIG. 1 is a schematic representation of an electromagnetic retarder with a cooling jacket according to a first embodiment of the invention;

FIG. 2 is a schematic representation of a cooling jacket according to the invention;

FIG. 3 is a schematic representation of the external wall of a cooling jacket according to the invention;

FIG. 4 is a schematic representation of a detail of the cooling jacket according to the invention, showing in particular one of the jacket couplings and the arrangement of two elastic seals according to the invention;

FIG. 5 is an axial view of a cooling jacket according to the first embodiment of the invention;

FIG. 6 and FIG. 7 show the change in the shape and cross-section of the coupling of the cooling jacket according to the invention;

FIG. 8 shows in detail the arrangement of the seals depicted in FIG. 4.

### DESCRIPTION OF A PREFERRED EMBODIMENT OF THE INVENTION

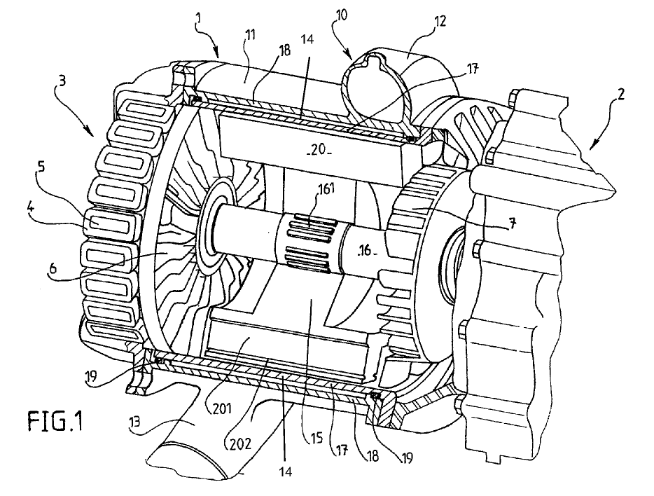

FIG. 1 depicts an electromagnetic retarder 1 according to the invention in a perspective view with partial axial section and mounted on a gear box 2 of a motor vehicle. This retarder, which is intended to retard a vehicle transmission shaft and more particularly here the output shaft of the gearbox 2, by generating a magnetic field with alternating distribution in a ferromagnetic piece, comprises a cooling jacket 10 characterised by the presence of a single helical-shaped conduit 11 a single turn.

The retarder 1 is equipped with a generator 3 intended to supply the excitation energy necessary for generating the alternating-distribution magnetic field. This generator 3 comprises an inducing stator formed by a ring of coils or windings 4 of electric wires around cores constituting multiple magnetic poles with alternating polarities, and a rotor 6 constituting an armature of this generator 3. The stator surrounds the rotor with a small air gap.

The coils 4 are supplied by a direct current source such as battery of the vehicle equipped with the retarder 1. The intensity of this current is regulated according to the braking torque that the retarder must produce. This is because, by regulating the intensity of the induction current of the coils 4, the intensity of the electric current generated by the generator 3 is regulated and, by this finally, the intensity of the eddy currents generating braking and heating, generated in a ferromagnetic piece 14 of the retarder, as described below.

The generation of the electric supply current necessary for the generation of the eddy currents, by a generator 3 integrated in the retarder 1, affords a dual advantage. The first advantage consists of a very small contribution of external electrical energy taken from the vehicle battery, for example around 20% to 30% of the total energy necessary. The second advantage is that the generation of the electric current by the generator itself consumes a certain amount of mechanical energy taken from the shaft to be retarded.

In order to obtain the required braking effect, the retarder 1 comprises a rotor 15 having a spindle 16 mounted to as to rotate inside a stator 14 and intended to be rotationally connected with the rotary shaft to be retarded. The spindle 16, which is provided with flutes 161 intended for fixing the rotor 15 to the spindle 16, carries a centrifugal fan 7 for cooling the rotor 15.

The excitation current generated by the generator 3 is used by coils 20 of the rotor 15 of the retarder 1 to generate an alternating magnetic field. The coils are formed by windings of electric wires around cores 201 forming integral parts of the rotor 15. Each core 201 has grooves 202 for receiving the winding, FIG. 1 showing symbolically only one of these in order not to burden the drawing. The magnetic field induces the stator 14 of the retarder 1 and generates eddy currents therein, in particular in the bottom part of the stator 14 produced from ferromagnetic material. The eddy currents being opposed, by their effects, to the cause that gives them the direction, namely the rotation movement of the rotor, the rotation movement of the rotor 15 thus generates a reverse rotation torque and therefore a braking torque.

The generation of the eddy currents being accompanied by heating, by Joule effect, of the bottom part of the stator 14, this part must be cooled in a particularly effective manner.

The stator 14 is cooled by the cooling jacket 10, which comprises, apart from the conduit 11, inlet 12 and outlet 13 couplings between which the conduit 11 extends. The bottom part of the stator 14 is an integral part of the jacket of the cooling jacket 10.

This is because, according to the principle of the present invention, the conduit 11 of the cooling jacket 10, which is depicted in more detail in FIGS. 4, 5 and 8, is delimited by a radially internal wall 17, a radially external wall 18, and two lateral walls 21, 22. The internal wall 17 is formed by a radially bottom part of the stator 14, or at least by a cylindrical wall of the stator, produced from a ferromagnetic material in which the eddy currents are generated. The external wall 18 is an integral part of an element produced in a single piece from a castable alloy and forming, apart from the conduit 11, the inlet coupling 12 and the outlet coupling 13. The conduit 11 has an at least approximately rectangular transverse section.

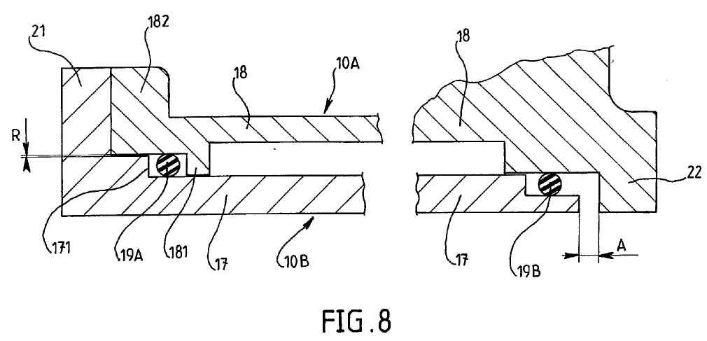

Advantageously, as depicted more particularly in FIGS. 4 and 8, the external wall 18 and the adjacent lateral wall 22 of the conduit 11 are integrated in, that is to say formed together in single piece 10A with, the top part produced in a castable alloy of the cooling jacket 10. And in a similar manner, the internal wall 17 and the adjacent lateral wall 21 are formed in a single piece 10B as the bottom part of the stator in a ferromagnetic material. The top 10A and bottom 10B parts are assembled with the interposing of two seals 19A and 19B.

The cooling jacket 10 has a cooling liquid running through it which advantageously comes from the cooling circuit of the vehicle. Thus the cooling jacket 10 limits the heating of the surface of the stator 14, a heating generated by the high-intensity eddy currents explained above.

Moreover, since the cooling jacket 10 advantageously extends over the entire axial length of the stator 14, seen in the direction of the orientation of the spindle 16 of the rotor 15, the surface of the chamber 10 has an area substantially equal to that of the surface of the stator 14 opposite which the external wall 28 of the cooling jacket is situated. The dissipation of the heat from the stator 14 therefore takes place over the entire surface of the cylindrical wall of the stator 14 in which the eddy currents are generated.

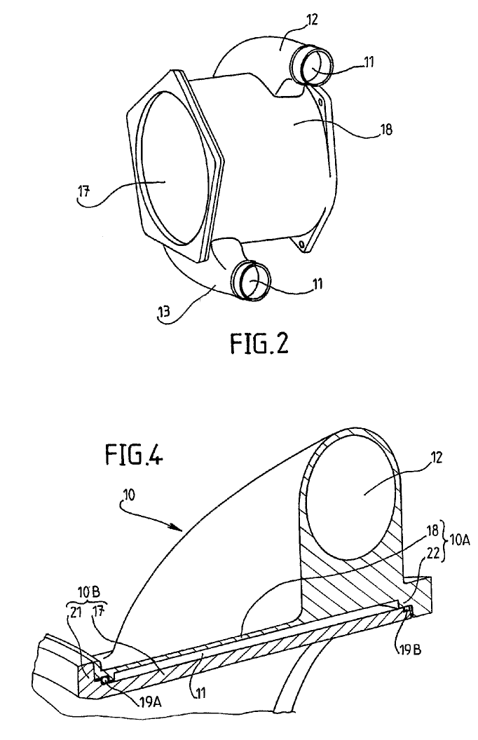

FIG. 2 shows the cooling jacket 10 in isolation, that is to say without the other pieces making up the retarder. In this FIG. 2, the internal wall 17 of the cooling jacket 10, which corresponds essentially to the stator 14 of the retarder 10 and forms an internal wall of the conduit 11, can be distinguished clearly. And likewise the external wall 18 of the cooling jacket 10, which corresponds essentially to an external wall of the conduit 11 of the cooling jacket 10 and comprises the inlet 12 and outlet couplings for a cooling fluid, can be distinguished.

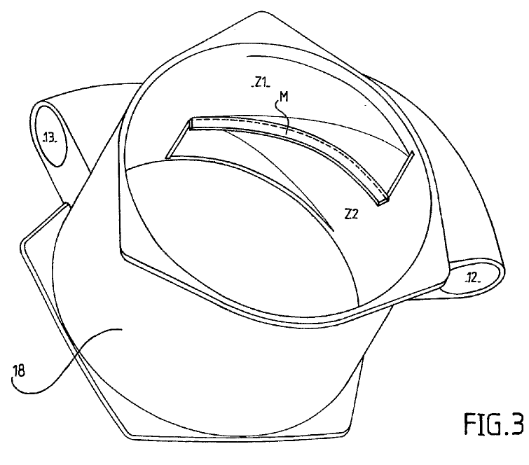

FIG. 3 depicts, in a perspective view, the external wall 18 of the cooling jacket 10. This view shows more particularly the circumferential extent of an inlet zone Z1 of the inlet coupling 12 and an outlet zone Z2 of the outlet coupling 13. The zones Z1 and Z2 correspond approximately to a tangential inlet of the cooling fluid through the inlet coupling 12 and a tangential outlet of the cooling fluid through the outlet coupling 13.

In order to ensure a constant flow through the single turn constituting the cooling jacket 10 according to this embodiment of the invention, the inlet and outlet couplings 12, 13 are conformed so as to have all along their longitudinal extent, a constant area of their cross-section of flow while taking account of the constructional particularities according to which in general use is made of a conduit with a circular cross section for the inlet and outlet conduits of a cooling circuit, whilst the transverse section of the cooling jacket in the part surrounding the rotary machine to be cooled has a generally rectangular cross-section.

FIG. 3 also shows that the inlet zone Z1 of the inlet coupling 12 and the outlet zone Z2 where the outlet coupling 13 commences are separated from each other by a changing low wall M conformed so as to grant the cooling fluid a favoured direction of flow.

This because the cooling fluid arrives in the zone 1 and at a fairly high speed and pressure and encounters fluid with a lower pressure emerging through the zone Z2. Although the exchange surface between the incoming flow and the outgoing flow is relatively small and therefore does not promote an appreciable interaction between the two flows, it could nevertheless happen the encounter between the two flows creates an area of turbulence greatly impairing the effective flow of the cooling fluid. To prevent this, the changing low wall M separates the inlet zone Z1 from the outlet zone Z2, the height of the wall M corresponding to the height of the helical circuit 11.

It goes without saying that, in a variant of the arrangement of the wall described above and without departing from the principle of the present invention, the wall can be formed also on the internal wall of the cooling jacket.

FIG. 4, and in more detail FIG. 8, shows the mechanical structure of the assembly of the top part 10A with the internal wall 17 and the bottom part 10B with the external wall 18, of the cooling jacket 10. These figures show more particularly that the two walls 17 and 18 are mounted with a degree of freedom in the axial direction with respect to each other. This axial clearance makes it possible to absorb the axial differential expansions between the internal 17 and external 18 walls during the various operating phases of the retarder and thus guarantees good durability for it. This axial clearance can attain a few millimetres, but is in general around one to two millimetres.

A radial clearance of a few tenths of a millimetre exists by construction in order to be able to assemble the top 10A and bottom 10B parts. This radial clearance, compatible with the differential expansions between the two parts 10A, 10B, is taken up by means of two O-ring seals 19a, 19B positioned on each side of the cooling jacket 10.

Advantageously, the external wall 18 is produced from an aluminium alloy and the internal wall 17 from a steel with a high limit of elasticity. The coefficients of expansion of these two materials, just like the thermal stresses, being different, the fact that each part can expand freely with respect to each other makes it possible to avoid internal stresses. Nevertheless, the materials are chosen so as to obtain compatible axial and radial expansions of the two internal 17 and external 18 walls.

The seal between the two internal 17 and external 18 walls is advantageously obtained by means of two O-ring seals 19A, 19B made from a high-temperature silicone in order to ensure good heat resistance, whilst keeping good resistance to the cooling fluid. A particular care is given to the surfaces in contact in order to limit premature wear on the said surfaces and seals.

As depicted in detail in FIG. 8, by extraction from FIG. 4, the external wall 18 is provided, on the opposite face of the internal wall 18 and close to the side intended to be in contact with the lateral wall 21, with a partition 181. This partition 181 delimits, together with a shoulder 171 produced at the junction of the internal 17 and lateral 21 walls, a volume intended to receive the O-ring seal 19A. The walls 17 and 18 being mounted with a radial clearance of around a few tenths of a millimetre, the seal 19A is not compressed as far as crushing. The height of the partition 181 is also advantageously determined so as to prevent the seal 19A being, even momentarily, entirely crushed, which would remove its elasticity and therefore its sealing effectiveness.

Given that the seal 19A is stressed solely in the radial direction, since the walls 17 and 18 are fixed on the side of the lateral wall 21 by fixing means such as bolts, this seal is not necessarily an O-ring seal. It may just as well consist of a flat seal or a lip seal. According to a variant embodiment, not shown in the drawings but not departing from the scope of the present invention, the walls 17 and 18 are provided with grooves intended to receive together the seal 19A.

On the lateral wall 22 side, the internal wall 17 is formed and dimensioned so as to simultaneously delimit a volume intended to receive the seal 19B and allow an axial clearance A of around a few millimetres resulting from the differences in temperature, which may attain some 300 degrees. Because of the essentially axial force that the seal 19B undergoes, the latter is advantageously an O-ring seal. However, it is also conceivable for a lip seal to be used in its place if the size of the axial clearance A so permits.

It goes without saying that the walls 17 and 18 are mounted, on the lateral wall 22 side, also with a radial clearance R corresponding to the one provided on the lateral wall 21 side.

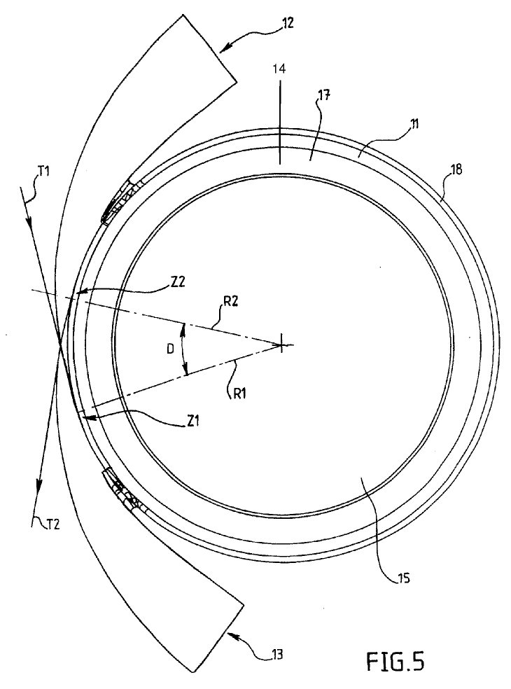

In order to obtain the best result possible with the cooling jacket according to the invention, in particular when the height of the jacket is relatively small, the helical conduit 11 of the cooling jacket 10 depicted in FIG. 5 in an axial view is provided with an inlet coupling 12 and an outlet coupling 13, both tangential. The “tangential” characteristics indicates that the couplings 12 and 13 are each orientated, the inlet coupling 12 in a circumferential inlet zone Z1 and the outlet coupling 13 in a circumferential outlet zone Z2 of the conduit 11, at least approximately along a tangent T1 passing through the centre of the zone Z1 and at least approximately along a tangent T2 passing through the centre of the zone Z2. The centres of the zones Z1 and Z2 are determined by the radii R1 and R2 ending on the circumference of the conduit 11. Advantageously, the inlet Z1 and outlet Z2 zones are disposed with an angular offset D of around 20° to 30°.

The arrangement of the inlet 12 and outlet 13 couplings with a relative angular shift between the two, and in particular with a relatively small angular offset as indicated above, corresponds to a configuration considered to be advantageous for embodiments where the helical conduit 11 surrounding the retarder 1 comprises only a single turn or where the portion of the cooling liquid in question therefore runs, comparatively quickly, through a single turn and immediately leaves the helical conduit. The result is good cooling over the entire width of the conduit 11.

By virtue of the tangential arrangement of the inlet and outlet couplings, there is no detrimental turbulence at the inlet and outlet zones that otherwise would have the effect of constituting a high flow resistance detrimental both to the speed of the cooling fluid and to the capacity for heat transfer from the heat retarder to the cooling fluid.

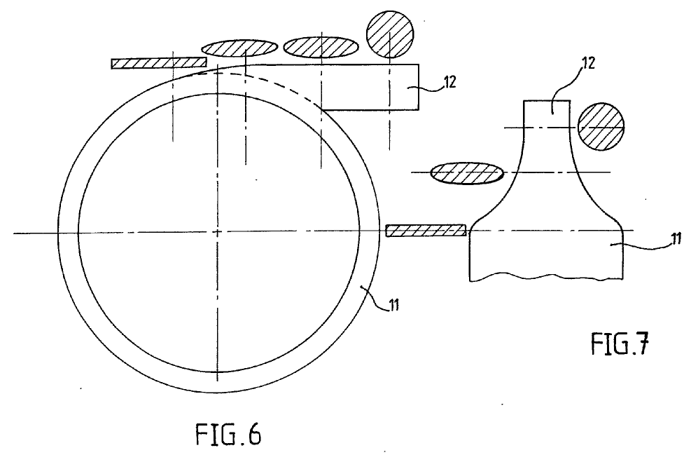

According to one of the advantageous characteristics of the cooling jacket of the invention, a characteristic that has already been mentioned above, the inlet coupling 12, the outlet coupling 13 and the conduit 12 have, all along their respective longitudinal and circumferential extents, a constant area of their cross-section of flow. FIG. 6 in this regard shows the conduit 11 of a cooling jacket 10 according to the invention with an inlet coupling 12. The cross-section of flow of the inlet coupling 12 is therefore depicted above the latter at four different points in order to thus demonstrate the change in shape of the cross-section of flow whilst keeping the passage area constant. In a similar manner, FIG. 6 depicts, schematically in a lateral view, the coupling 12 and the start of the conduit 11. The cross-section of flow of the inlet coupling 12 is depicted alongside the latter at three different points in order to thus demonstrate the change in shape of the cross section of flow whilst keeping the passage area constant.

According to a variant embodiment, not described in detail here, the cooling jacket can also be implemented by a tube surrounding the stator 14 in the form of a plurality of helical turns or in the form of a plurality of substantially annular conduits surrounding the stator almost entirely and parallel to one another and connected respectively to a common inlet coupling and to a common outlet coupling.

Whatever the variant embodiment chosen, the result in all cases is a top part 10A with a complex shape. In order to produce such shapes, the solution of the present invention affords a precious aid: the production of the part 10A from a castable material.

1. A cooling jacket for a rotary machine, said cooling jacket comprising at least one conduit intended to be in heat-transfer contact with at least part of the machine to be cooled and having at least one inlet coupling and at least one outlet coupling for a cooling fluid between which a conduit or conduits extend; said cooling jacket further comprising:
an internal wall and an external wall produced in two different materials, said external wall surrounding said internal wall and being formed radially spaced apart therefrom in order to form said conduit or conduits.

2. The cooling jacket according to claim 1, wherein said internal wall is produced from a magnetic material and said external wall is produced from a non-magnetic material.

3. The cooling jacket according to claim 1, wherein said external wall is produced from a castable material.

4. The cooling jacket according to claim 1, wherein said external wall and said internal wall have an axial clearance with respect to each other.

5. The cooling jacket according to claim 1, wherein said external wall and said internal wall are assembled with two elastics seals in order to ensure the fluid tightness of said conduit or conduits.

6. The cooling jacket according to claim 1, wherein said external wall and said internal wall have with respect to each other a radial clearance compensated for by two elastic seals.

7. The cooling jacket according to claim 1, wherein said external wall is produced from a light alloy based on aluminum or magnesium.

8. The cooling jacket according to claim 1, wherein said internal wall is produced from a magnetic steel with a high limit of elasticity.

9. The cooling jacket according to claim 5, wherein said elastic seal is an O-ring seal.

10. The cooling jacket according to claim 1, wherein said internal wall has essentially the shape of a straight cylinder.

11. The cooling jacket according to claim 1, wherein said conduit or conduits is/are a helical conduit having at least one turn intended to surround at least part of the machine to be cooled and having respectively an inlet axis and an outlet axis orientated along a tangential axis or plane passing through a respectively inlet and outlet circumferential zone of the cooling jacket.

12. The cooling jacket according to claim 1, wherein said inlet coupling and said outlet coupling are disposed, in an axial view of the cooling jacket, with a slight angular offset between the two couplings.

13. The cooling jacket according to claim 1, wherein said inlet coupling, said outlet coupling and said conduit have, all along the path of the cooling fluid, a constant area of their cross section of flow.

14. The cooling jacket according to claim 1, wherein said inlet coupling or couplings and said outlet coupling or couplings are each orientated at least approximately along the orientation of the inlet axis of the outlet axis of the corresponding conduit.

15. The cooling jacket according to claim 1, wherein said external wall is conformed on the side orientated towards said internal wall so as to grant the cooling fluid a helical path with a single turn.

16. The cooling jacket according to claim 15, wherein said external wall comprises a changing low wall conformed so as to give the cooling fluid a favored direction of flow.

17. A rotary electrical machine comprising a stator surrounding a rotor, the stator and the rotor being axially orientated, wherein said rotary electrical machine comprises a cooling jacket according to claim 1, intended to cool the stator.

18. The rotary electrical machine according to claim 17, wherein the internal wall of the cooling jacket forms part of the stator of the machine.

19. An electromagnetic retarder comprising a stator surrounding a rotor, the stator and the rotor being axially orientated, wherein said retarder comprises a cooling jacket according to claim 1, intended to cool the stator.

20. An electric machine comprising:
a cooling jacket comprising at least one conduit for receiving a cooling fluid, said cooling jacket further comprising:
a first wall and a generally opposed second wall, said second wall surrounding said first wall and being formed radially space apart from said second wall in order to form said at least one conduit;
said first wall being made from a first material and said second wall being made from a second material.

21. The electric machine as recited in claim 20, wherein said first wall is produced from a magnetic material and said second wall is produced from a non-magnetic material.

22. The electric machine as recited in claim 20, wherein said second wall is produced from a castable material.

23. The electric machine as recited in claim 20 wherein said first wall is made from a magnetic material.

24. The electric machine as recited in claim 23, wherein said external wall is produced from a light alloy based on aluminum or magnesium.
